(19) United States
(12) Patent Application Publication
(10) Pub. No.: US 2016/0072179 A1
(43) Pub. Date: Mar. 10, 2016

(54) HOLLOW COMPOSITE STRUCTURE USED AS WAVEGUIDE

(71) Applicant: SIKORSKY AIRCRAFT CORPORATION, Stratford, CT (US)

(72) Inventors: Cagatay Tokgoz, South Windsor, CT (US); Nicholas Charles Soldner, Southbury, CT (US); Joseph Zacchio, Wethersfield, CT (US)

(21) Appl. No.: 14/784,221

(22) PCT Filed: Feb. 12, 2014
(86) PCT No.: PCT/US14/16040

§ 371 Date: Oct. 13, 2015

Related U.S. Application Data
(60) Provisional application No. 61/811,420, filed on Apr. 12, 2013.

(51) Int. Cl. H01Q 1/28; H02J 17/00; H04B 1/04; H01Q 1/24

(52) U.S. Cl. CPC H01Q 1/28; H01Q 1/24; H02J 17/00; H04B 1/04

(57) ABSTRACT

Embodiments of the invention include a system including a spar of a wing having an outer body defining a hollow cavity in the outer body, a first communication assembly including a receiver and a first antenna connected to the receiver for receiving one or both of electrical signals and power, the first antenna located in the hollow cavity, and a second communication assembly. The second communication assembly includes a second antenna located in the hollow cavity and an electrical device. The second communication assembly is configured to transmit, by the second antenna, one or both of electrical signals and power through the hollow cavity to the first antenna.

### STATEMENT OF FEDERAL SUPPORT

This invention was made with Government support under contract No. W911W6-11-2-0004 awarded by the U.S. Army. The Government has certain rights in the invention.

### BACKGROUND OF THE INVENTION

Conventional vehicle systems use electrical wiring to transmit power and data through wings or spars. Wiring may add weight to a vehicle or may be impractical in some applications, such as in some rotary-wing vehicles.

### BRIEF DESCRIPTION OF THE INVENTION

Embodiments of the invention relate to a system including a spar of a wing having an outer body defining a hollow cavity in the outer body. The system includes a first communication assembly including a receiver and a first antenna connected to the receiver for receiving one or both of electrical signals and power, the first antenna located in the hollow cavity. The system also includes a second communication assembly including a second antenna located in the hollow cavity and an electrical device, the second communication assembly configured to transmit, by the second antenna, one or both of electrical signals and power through the hollow cavity to the first antenna.

In the above embodiment, or in the alternative, the first antenna may be connected to a transceiver to transmit and receive one or both of electrical signals and power to the second antenna through the hollow cavity, and the second communication assembly may be configured to transmit, by the second antenna, electrical signals to the first antenna based on receiving one or both of the electrical signals and power from the first antenna.

In the above embodiments, or in the alternative, the first antenna may be connected to a power source, and the first communication assembly may be configured to transmit power, by the first antenna, to the second antenna to power the electrical device. In addition, the second communication assembly may be configured to transmit, by the second antenna, electrical signals to the first antenna through the hollow cavity based on receiving power from the first antenna through the hollow cavity.

In the above embodiments, or in the alternative, the electrical device may be a sensor, and the second communication assembly may be configured to transmit, by the second antenna, sensor signals corresponding to sensed characteristics through the hollow cavity to the first antenna.

In the above embodiments, or in the alternative, the sensor may be located outside the spar, and the sensor may be connected to the second antenna by a wire through the outer body of the spar.

In the above embodiments, or in the alternative, the second communication assembly may be configured to transmit, by the second antenna, radio frequency (RF) signals through the hollow cavity to the first antenna.

In the above embodiments, or in the alternative, the first communication assembly may be configured to transmit, by the first antenna, one or more of control data, configuration data, timing data, and communication request data to the second antenna through the hollow cavity, and the second communication assembly may be configured to transmit, by the second antenna, data to the first antenna based on receiving the one or more of control data, configuration data, timing data, and communication request data.

In the above embodiments, or in the alternative, the hollow cavity may be an enclosed cavity capped at each end.

In the above embodiments, or in the alternative, the wing may be a fixed wing of an aircraft.

In the above embodiments, or in the alternative, the wing may be a rotary wing of an aircraft.

Embodiments of the invention further relate to a method including transmitting, by a first antenna located in a hollow cavity of a spar of a wing, one or both of electrical signals and power to a second antenna located in the hollow cavity of the wing, and transmitting, by the second antenna, one or both of electrical signals and power to the first antenna based on receiving one or both of electrical signals and power from the first antenna through the hollow cavity.

In the above embodiment, or in the alternative, transmitting, by the first antenna, one or both of electrical signals and power to the second antenna may include transmitting power from the first antenna to the second antenna to power a sensor, and transmitting, by the second antenna, one or both of electrical signals and power to the first antenna may include transmitting sensor signals to the first antenna.

In the above embodiments, or in the alternative, the sensor signals may be generated by a sensor located outside the spar, and the method may include transmitting the sensor signals via a wire through a wall of the spar to the second antenna.

In the above embodiments, or in the alternative, transmitting, by the second antenna, one or both of electrical signals and power to the first antenna may include transmitting radio frequency (RF) signals through the hollow cavity to the first antenna.

In the above embodiments, or in the alternative, transmitting, by the first antenna, one or both of electrical signals and power to the second antenna may include transmitting one or more of control data, configuration data, timing data, and communication request data to the second antenna.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a vehicle wing communication system according to an embodiment of the invention;

FIG. 2 is a side cross-section view of a vehicle wing communication system according to an embodiment of the invention;

FIG. 3 is a side cross-section view of a vehicle wing communication system according to another embodiment of the invention; and

FIG. 4 is a flow diagram of a method of transmitting electrical signals according to an embodiment of the invention.

### DETAILED DESCRIPTION OF THE INVENTION

Conventional power and communications systems in vehicle wings include wiring run through the wings. Embodiments of the invention relate to use of a cavity in a spar of a wing as a waveguide to transmit one or both of data and power.

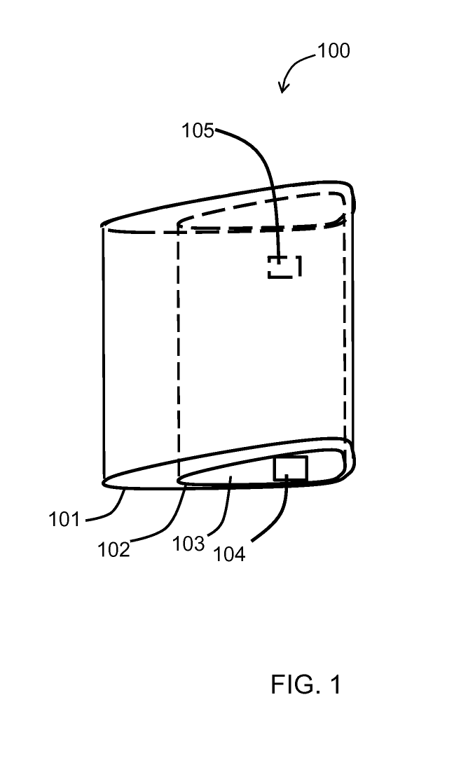

FIG. 1 illustrates perspective view of a vehicle wing communication system according to one embodiment of the invention. The system 100 includes a wing 101 and a spar 102 located in the wing 101, the spar 102 defining a hollow cavity 103. A first communication assembly 104 is located in the hollow cavity 103, and a second communication assembly 105 is also located in the hollow cavity a predetermined distance from the first communication assembly 104. In one embodiment, each communication assembly 104 and 105 includes an antenna. In one embodiment, the first communication assembly is configured to transmit one or both of data and power to the second communication assembly 105 using the hollow cavity 103 (or the walls of the hollow cavity 103) as a waveguide. In one embodiment, the second communication assembly 105 is also configured to transmit one or both of data and power to the first communication assembly 104 using the hollow cavity 103 as a waveguide.

While FIG. 1 illustrates only one spar 102 for purposes of description, embodiments of the invention encompass wing assemblies having any number of spars, each spar defining cavities of any shape, including square, circular, ovoid, trapezoidal, or any other geometric or irregular shape. The hollow cavity 103 may be filled with air or any other fluid or other material that is not lossy. In embodiments of the invention, the wing 101 is part of a vehicle. In some embodiments, the wing is part of a rotary wing vehicle, such as a helicopter, and the wing is a rotor of the rotary-wing vehicle. In another embodiment, the wing is a fixed wing of an airplane. However, embodiments of the invention encompass wings of any type of vehicle, including land-based or wheeled vehicles having wings, blades or spars.

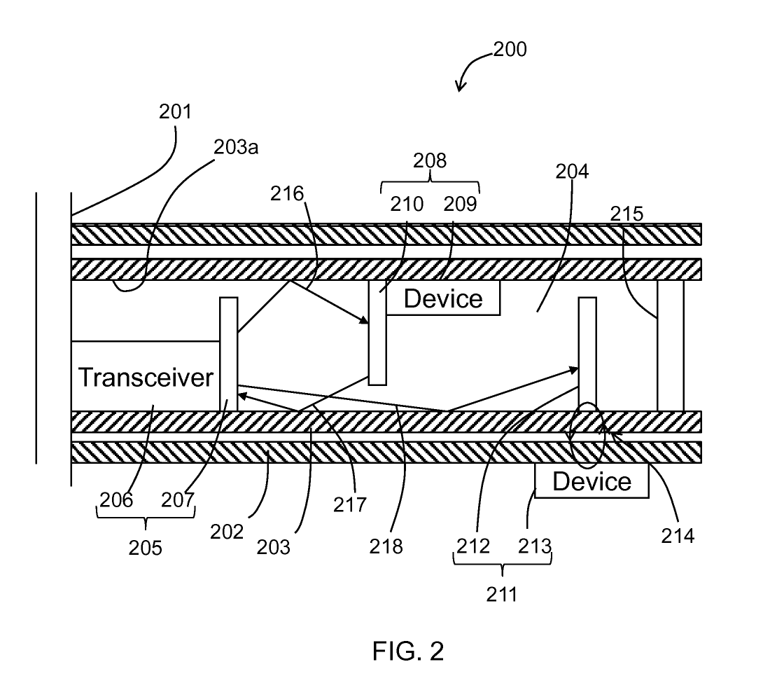

FIG. 2 illustrates a side cross-sectional view of a wing communication system 200 according to an embodiment of the invention. The system 200 includes a wing 202 attached to a vehicle body 201. A spar 203 is located within the wing 202 to provide structural support to the wing 202. While FIG. 2 illustrates a spar 203 that is a structure separate from the outer structure of the wing 202, in some embodiments the wing 202 itself acts as a spar, or in other words, a cavity is formed in the wing 202 to act as a spar to provide structural support. In other embodiments, multiple spars are formed in a wing or connected to a wing housing to provide structural support to the wing.

The spar 203 defines a hollow cavity 204, and the walls 203a of the spar act as waveguides to transmit electromagnetic waves along the hollow cavity 204. The system 200 includes a first communication assembly 205 and a second communication assembly 208. Embodiments of the invention further include any additional number of communication assemblies, such as the third communication assembly 211 and any other communication assemblies. The first communication assembly 205 includes an antenna 207 connected to a transceiver 206, capable of generating signals to transmit from the antenna 207 and processing signals received by the antenna 207. The second communication assembly 208 includes an antenna 210 connected to an electrical device 209, and the third communication assembly 211 includes an antenna 212 connected to an electrical device 213. The hollow cavity 204 may be closed at one or both ends by caps 215.

In embodiments of the invention, the first communication assembly 205 transmits one or both of power and data via electromagnetic waves 216 and 217 to the second and third communication assemblies 208 and 211. In one embodiment, the electromagnetic waves 216 and 218 are radio frequency (RF) signals. In one embodiment, the first communication assembly 205 transmits configuration data or timing data to one or both of the second and third communication assemblies 208 and 211. In another embodiment, the first communication assembly 205 transmits a data request, such as a system analysis request, or a request for other information, to one or both of the second and third communication assemblies 208 and 211. In yet another embodiment, the first communication assembly 205 transmits electromagnetic waves at predetermined frequencies, amplitudes, or having predetermined modulations to cause electrical structures, such as inductive components, in the second and third communication assemblies 208 and 211 to generate power. In this manner, the first communication assembly 205 may transmit power to the second and third communication assemblies 208 and 211. In some embodiments, the electromagnetic signals that generate power in the second and third communication assemblies 208 and 211 also contain data that is usable by the second and third communication assemblies 208 and 211 for operating the second and third communication assemblies 208 and 211. While some examples of types of data have been provided, embodiments of the invention encompass the transmission of any type of data from the first communication assembly 205 to the second and third communication assemblies 208 and 211.

In one embodiment, one or both of the devices 209 and 213 is a sensor to detect characteristics inside or outside the spar 203 or wing 202. Examples of data that may be sensed by the devices 209 and 213 include strain data, temperature, velocity, acceleration, pitch or angle, or any other type of data that may be sensed by a sensor.

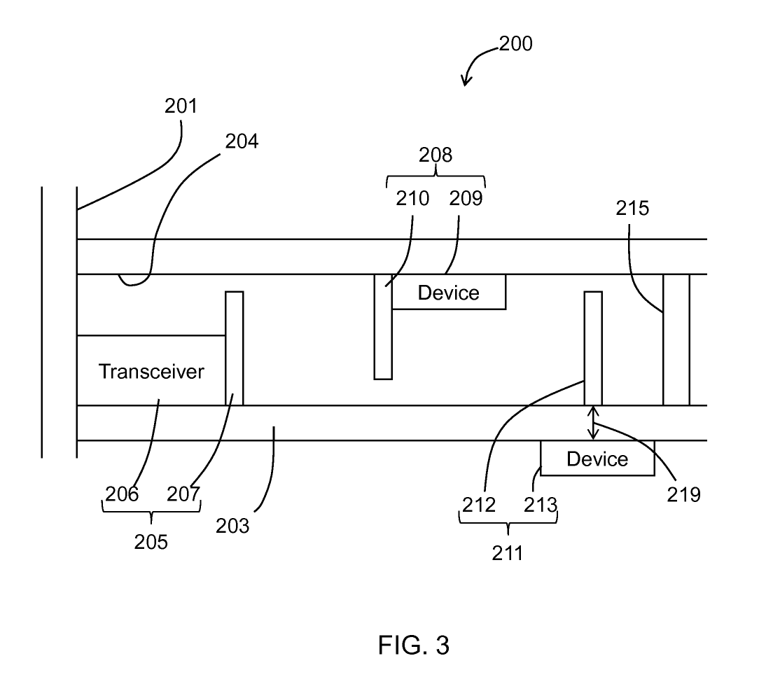

As illustrated by the device 213 in FIG. 2, an electronic device may be located outside one or both of the spar 203 and the wing 202 and may communicate with an antenna inside the spar 203 or wing 202. As illustrated in FIG. 2, the electrical device 213 is located outside the wing 202 and communicates with the antenna 212 via inductive coupling, or without the use of wires between the devices. However, as illustrated in FIG. 3, in another embodiment, the device 213 is connected to the antenna 212 via one or more wires that extend through the wing 202, spar 203, or both, depending upon the location of the device 213. For example, if an electronic device is located outside the spar 203 but inside the wing 202, wires connecting the electronic device to an antenna inside the spar would extend only through the spar and not through the wing. In addition to wires, other conductive materials may be used to transmit power and data through the spar 203 and wing 202.

In one embodiment, the electrical devices 209 and 213 include rectifier circuits or any other circuitry necessary to drive the electrical devices 209 and 213, perform sensing functions, or transmit signals via the antennae 210 and 212.

In one embodiment, the cap 215 is located within the spar 203 to improve signal transmission within the hollow cavity 204. As illustrated in FIG. 2, the end cap 215 may be inserted within the body of the spar 203. However, in another embodiment, an end cap may be attached to the end of the spar 203. In the embodiment illustrated in FIG. 2, the vehicle body 201 acts as an end cap. However, in an alternative embodiment, a separate end cap may be inserted within the spar 203 adjacent to the vehicle body 201.

In embodiments of the invention, the antenna 207, 210 and 212 within the hollow cavity 204 are positioned at predetermined distances from the end caps (such as the vehicle body 201 and the end cap 215, in FIG. 2) to improve signal transmission within the hollow cavity 204. The predetermined distances may be based on the signal frequency of the signals transmitted in the cavity. In addition, the signal frequency may be determined based on the shape of the cavity. In one embodiment, an antenna is located a quarter wavelength from each end (cap end and vehicle body end) of the spar or hollow cavity.

In one embodiment, the antennae 207, 210, and 212, the transceiver 206, and the electrical device 209 are mounted directly within the hollow cavity 204, without providing additional reflective or conductive layers on the inside surfaces 203a of the spar 203. For example, in an embodiment in which the spar 203 is made of carbon, the carbon material may make up the inside surface 203a of the hollow cavity 204. In one embodiment, the spar 203 is made up of a composite material including layers having different physical properties. In one embodiment, a layer of conductive material lines the inside of the cavity 204. For example, a tin, nickel, aluminum or copper layer may make up the inside surface 203a of the cavity 204, and the spar 203 may be made of additional materials, such as carbon composite materials. In one embodiment, the spar 203 is made of a conductive composite surrounded by a resin. As discussed above, in one embodiment, the wing itself is the spar, or in other words, the wing defines a cavity in which the antennae and other electrical devices are located, and additional spars or mechanical supports are not located in the wing.

In one embodiment, one or more of the antennae 207, 210, and 212 are electrically isolated from the side walls 203a of the cavity 204 to form an open-ended probe. In another embodiment, the one or more antennae 207, 210, and 212 contact the side walls 203a to form a shorted-end probe. In embodiments of the invention, the antennae 207, 210, and 212 may include any type of antenna, including linear antennae, loop antennae, slot antennae or any other type of antenna.

In one embodiment, the transceiver 206 is mounted to, or part of, an actuator within the wing 202 or spar 203, such as a flap on a wing 202. In one embodiment, the transceiver 206 includes or is connected to a power supply that transmits power to the second and third communication assemblies 208 and 211 by electromagnetic signals. In one embodiment, the first communication assembly 205 transmits one or both of data and power to the second and third communication assemblies 208 and 211, and the second and third communication assemblies 208 and 211 transmit data to the first communication assembly 205 based on receiving the power or data from the first communication assembly 205. For example, the first communication assembly 205 may transmit power to activate an electronic device 209, and the electronic device 209 may generate sensor data upon being activated, and may transmit the sensor data to the first communication assembly 205. In another embodiment, the first communication assembly 205 may transmit a request for data to the second communication assembly 208, and the electrical device 209 may transmit data to the first communication assembly 205 in response to the data request.

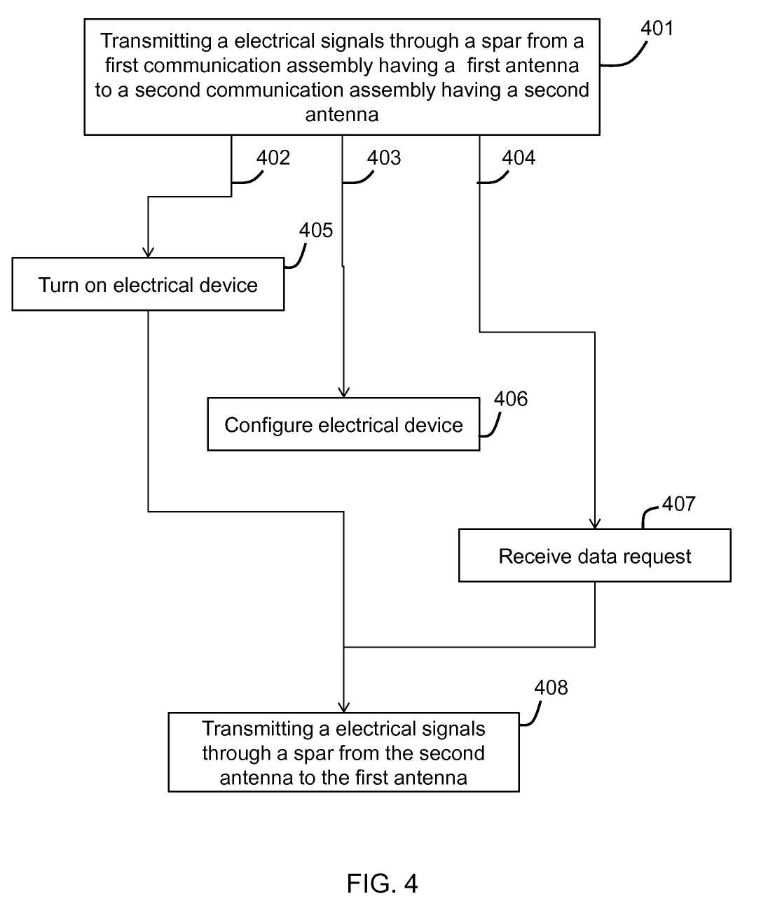

FIG. 4 illustrates a method according to an embodiment of the invention. In block 401, electrical signals are transmitted through a hollow cavity in a wing or spar from a first communication assembly having a first antenna to a second communication assembly having a second antenna. The electrical signals may include power or other data signals. Reference numeral 402 represents the transmission of power from the first communication assembly to the second communication assembly. In block 405, an electrical device of the second assembly is turned on based on receiving the power from the first communication assembly.

In block 408, the second communication assembly transmits electrical signals through the spar from the second communication assembly to the first communication assembly. For example, the electrical device, having received power, may activate a sensor or data stored in memory and may transmit the data to the first communication assembly with the received power.

Reference numeral 403 represents the transmission of configuration data from the first communication assembly to the second communication assembly. In block 406, an electrical device of the second communication assembly is configured by the configuration data. Although a return communication to the first communication assembly is not illustrated in FIG. 4, embodiments encompass communication from the second communication assembly to the first communication assembly based on the electrical device being configured with the configuration data received from the first communication assembly.

Reference numeral 404 represents the transmission of a data request from the first communication assembly to the second communication assembly. In block 407, an electrical device of the second communication assembly receives the data request, and in block 408, the second communication assembly transmits data to the first communication assembly based on the data request. For example, the data request may correspond to a request for a status of one or more electrical devices of the second communication assembly, a request for sensor data, a request for a subset of data stored in memory of the second communication assembly, or any other data stored or obtainable by the second communication assembly.

While FIG. 4 illustrates only a few examples of electrical signals communicated between a first communication assembly in a spar or wing communication system and a second communication assembly, embodiments of the invention encompass any type of electrical signal transmission, including power and data transmission.

Modern aerospace structures increasingly use conductive composite structures. Frequently hollow structures can act as efficient electromagnetic waveguides. One material commonly used in modern structures is graphite. Graphite has a good conductivity, although composite materials including graphite will have conductivities that vary according to the characteristics of the different materials in the composite. Since graphite has a high reflection coefficient, electromagnetic waves do not penetrate into graphite.

A wing or spar that is made of graphite or a composite including graphite or another high-reflectivity material may be treated as a rectangular waveguide. Transverse electric (TEₘₙ) modes can be excited along a composite structure above their cut-off frequencies. Embodiments of the invention encompass wings, spars, and associated systems including graphite or any other materials having high-reflection coefficients, and of such a size as to correspond to any desired TEₘₙ modes, according to design considerations of the wing, spar, or system.

Embodiments of the invention utilize a hollow conductive composite structure as a waveguide for both power transfer and communications. One aspect of embodiments of the invention relates to design of an efficient waveguide feed also known as a waveguide transition. The feed is responsible for transitioning voltage and current (power) into a propagating wave within the hollow structure. In one embodiment, a capacitive probe is used which excites the TE₁₀ mode, although other higher modes can also be excited. A shorted end probe can also be used to excite magnetic fields also resulting in the propagation of different TM modes.

A technical effect of the invention is the transmission of data and power through existing support structures in wings or spars without the use of wires.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system, comprising:
a spar of a wing having an outer body defining a hollow cavity in the outer body;
a first communication assembly including a receiver and a first antenna connected to the receiver for receiving one or both of electrical signals and power, the first antenna located in the hollow cavity;
a second communication assembly including a second antenna located in the hollow cavity and an electrical device, the second communication assembly configured to transmit, by the second antenna, one or both of electrical signals and power through the hollow cavity to the first antenna.

2. The system of claim 1, wherein the first antenna is connected to a transceiver to transmit and receive one or both of electrical signals and power to the second antenna through the hollow cavity, and
the second communication assembly is configured to transmit, by the second antenna, electrical signals to the first antenna based on receiving one or both of the electrical signals and power from the first antenna.

3. The system of claim 2, wherein the first antenna is connected to a power source, and the first communication assembly is configured to transmit power, by the first antenna, to the second antenna to power the electrical device, and
the second communication assembly is configured to transmit, by the second antenna, electrical signals to the first antenna through the hollow cavity based on receiving power from the first antenna through the hollow cavity.

4. The system of claim 1, wherein the electrical device is a sensor, and the second communication assembly is configured to transmit, by the second antenna, sensor signals corresponding to sensed characteristics through the hollow cavity to the first antenna.

5. The system of claim 4, wherein the sensor is located outside the spar, and
the sensor communicates with the second antenna by inductive coupling through the outer body of the spar.

6. The system of claim 1, wherein the second communication assembly is configured to transmit, by the second antenna, radio frequency (RF) signals through the hollow cavity to the first antenna.

7. The system of claim 1, wherein the first communication assembly IS configured to transmit, by the first antenna, one or more of control data, configuration data, timing data, and communication request data to the second antenna through the hollow cavity, and
the second communication assembly is configured to transmit, by the second antenna, data to the first antenna based on receiving the one or more of control data, configuration data, timing data, and communication request data.

8. The system of claim 1, wherein the hollow cavity is an enclosed cavity capped at each end.

9. The system of claim 1, wherein the wing is a fixed wing of an aircraft.

10. The system of claim 1, wherein the wing is a rotary wing of an

[symbol]

11. A method, comprising:
transmitting, by a first antenna located in a hollow cavity of a spar of a wing, one or both of electrical signals and power to a second antenna located in the hollow cavity of the wing; and
transmitting, by the second antenna, one or both of electrical signals and power to the first antenna based on receiving one or both of electrical signals and power from the first antenna through the hollow cavity.

12. The method of claim 11, wherein transmitting, by the first antenna, one or both of electrical signals and power to the second antenna includes transmitting power from the first antenna to the second antenna to power a sensor, and transmitting, by the second antenna, one or both of electrical signals and power to the first antenna includes transmitting sensor signals to the first antenna.

13. The method of claim 12, wherein the sensor signals are generated by a sensor located outside the spar, and
the method includes transmitting the sensor signals via a wire through a wall of the spar to the second antenna.

14. The method of claim 11, wherein transmitting, by the second antenna, one or both of electrical signals and power to the first antenna includes transmitting radio frequency (RF) signals through the hollow cavity to the first antenna.

15. The method of claim 11, wherein transmitting, by a first antenna, one or both of electrical signals and power to the second antenna includes transmitting one or more of control data, configuration data, timing data, and communication request data to the second antenna.
